(19) United States
(12) Patent Application Publication
(10) Pub. No.: US 2025/0010354 A1
(43) Pub. Date: Jan. 9, 2025

(54) ZERO SCRAP MANUFACTURING METHODS FOR METAL CONTAINERS, AND ASSOCIATED TOOLING

(71) Applicant: Stolle Machinery Company, LLC, Centennial, CO (US)

(72) Inventors: Stephen D. Christensen, Highlands Ranch, CO (US); John Nigel Grainger, Steeton (GB)

(73) Assignee: Stolle Machinery Company, LLC, Centennial, CO (US)

(21) Appl. No.: 18/218,247

(22) Filed: Jul. 5, 2023

(51) Int. Cl. B21D 51/26; B21D 5/16; B23K 20/12

(52) U.S. Cl. CPC B21D 51/2676; B21D 5/16; B23K 20/1255; B23K 2101/125

(57) ABSTRACT

A zero-scrap method and associating tooling for manufacturing can bodies is provided. A metal sheet is shorn into strips, and each strip is wound to form a cylindrical tube. Each tube is cut into two or more can bodies using a zigzagged pattern, such that each can body has one planar edge and one zigzagged edge with triangular formations. Each can body is mounted on a mounting base for support while steps are performed to form the zigzagged edge into the can body base. A folding die folds the triangular formations until their apexes all coincide with one another and with the central axis of the can body. A flattening die then flattens the folded formation into a flat end of the can body. A friction stir welding assembly then stir welds the entire flat end of the can body at one time in order to seal all seams.

### FIELD OF THE INVENTION

The disclosed concept relates generally to metal containers, such as beer/beverage cans and food cans, and, more particularly, to methods of manufacture for metal containers and associated tooling.

### BACKGROUND OF THE INVENTION

Metallic containers (e.g., cans) for holding products such as, for example, liquids, beverages, or food products, are typically produced as either two-piece or three-piece cans. Two-piece cans in particular are generally manufactured by first separately producing a can body and a can end, the can body having an integrally formed base, and then joining the can end to the open top end of the can body to form the full can. During mass production of can bodies, rectangular metallic sheets are used to produce the can bodies, such that several can bodies can be produced from each rectangular metallic sheet. With each rectangular sheet, the first step is to punch several discs out of the rectangular sheet. Next, each disc is formed into a small cup. Typically, the outer diameter of the cup is about 3 inches and the height of the cup is between 1 inch and 2 inches. The small cups then go through an ironing operation to draw them into a longer and narrower cylinder with an integrally formed base at one end of the cylinder.

Because the typical can body production process requires punching circular discs out of a rectangular sheet of material, there is leftover material at the edges of the sheet and also between adjacent discs. The amount of leftover scrap material is large and costly to can manufacturers.

There is, therefore, room for improvement in manufacturing methods for metal containers, such as beer/beverage cans and food cans, and in the tooling associated with such methods.

### SUMMARY OF THE INVENTION

These needs, and others, are met by embodiments of the disclosed concepts, which are directed to a zero-scrap method and associating tooling for manufacturing can bodies. First, a metal sheet is shorn into strips, and each strip is wound to form a cylindrical tube. Each tube is cut into two can bodies using a zigzagged pattern, such that each can body has one planar edge and one zigzagged edge with triangular formations. Each can body is mounted on a mounting base for support while steps are performed to form the zigzagged edge into the can body base. A folding die with a concave folding surface is used to fold the triangular formations until their apexes all coincide with one another and with the central axis of the can body. A flattening die with an end-flattening surface then flattens the folded formation into a flat end of the can body. A friction stir welding assembly that includes a stirring tool with a circular welding surface having a greater circumference than the flattened can end then stir welds the entire flattened end of the can body at one time in order to seal all seams of the flattened can end.

In one aspect of the disclosed concept, a method of manufacturing a body of a container comprises: providing a metal strip, winding the strip into a tube; between a first end of the tube and a second end of the tube opposite the first end, cutting along a zigzagged path to produce a can body, with a first end of the can body comprising a planar edge and a second end of the can body comprising a plurality of triangular formations, each triangular formation comprising an apex; forming a folded end by folding all of the triangular formations toward a central axis of the can body until each apex coincides with the central axis; forming a flattened end by flattening the folded end; and friction stir welding an entire external surface area of the flattened end at one time.

In another aspect of the disclosed concept, a can body tooling assembly comprises: a closing punch structured to mount a cylindrical can body and comprising a circular base and a cylindrical support extending from the circular base; a folding die, the folding die comprising a first solid body formed with a fold-forming cutout at a can receiving end; a closing die, the closing die comprising a second solid body formed with an end-flattening cutout at a can receiving end; and a friction stir welding tooling assembly. The friction stir welding tooling assembly comprises: a headstock; a stirring tool comprising a planar welding surface and coupled to the headstock in a manner that enables the stirring tool to rotate relative to the headstock; and a can stabilizing arrangement structured to hold the can body fixed in position such that a flattened end of the can body faces the welding surface. The fold-forming cutout is convex such that a concave fold-forming surface is formed in an interior of the first solid body.

In a further aspect of the disclosed concept, a container body comprises a first end comprising a planar edge and a second end disposed opposite the first end. The second end forms a planar base comprising a plurality of triangular formations welded together.

### BRIEF DESCRIPTION OF THE DRAWINGS

A full understanding of the invention can be gained from the following description of the preferred embodiments when read in conjunction with the accompanying drawings in which:

FIG. 1 shows a sheet of metal with markings indicating how the sheet is to be cut into strips so that each strip can be made into a can body, in accordance with an embodiment of the disclosed concept;

FIG. 2 is a side elevation view showing one of the strips of metal from FIG. 1 rolled into a tube, in accordance with an embodiment of the disclosed concept;

FIG. 3A shows a first embodiment of the tube shown in FIG. 2 with a zigzagged cutting pattern marked, along which the tube can be cut to form two small tubes used to form can bodies, in accordance with an embodiment of the disclosed concept;

FIG. 3B shows a second embodiment of the tube shown in FIG. 2 with alternating zigzagged cutting patterns and planar cutting patterns marked, along which the tube can be cut to form multiple small tubes used to form can bodies, in accordance with another embodiment of the disclosed concept;

FIG. 4 is a perspective view of the two can bodies that result from cutting the tube shown in FIG. 3A along the zigzagged cutting pattern marked in FIG. 3A, with the first end of each can body having a planar edge and the second end of can body having triangular formations that include burst points, in accordance with an embodiment of the disclosed concept;

FIG. 5A is a perspective view of one of the can bodies shown in FIG. 4 aligned for mounting onto the closing punch, in accordance with an embodiment of the disclosed concept;

FIG. 5B is a perspective view of the can body shown in FIG. 5A after being mounted onto the closing punch, in accordance with an embodiment of the disclosed concept;

FIG. 5C is another perspective view of the can body mounted on the closing punch as shown in FIG. 5B, with a folding die positioned to receive the second end of the can body, the folding die being shown in sectional view in order to show a folding surface formed in the interior of the folding die body, in accordance with an embodiment of the disclosed concept;

FIG. 5D shows a side view of the can body mounted on the closing punch and the sectional view of the folding die shown in FIG. 5C, after the folding die has been pressed onto the second end of the can body and folded the triangular formations of the second end of the small tube into a closed end, in accordance with an embodiment of the disclosed concept;

FIG. 5E shows a side view of the can body mounted on the closing punch with the triangular formations folded into a closed end as shown in FIG. 5D and a sectional view of the folding die shown in FIG. 5D, after the folding die has been removed from the second end of the can body, in accordance with an embodiment of the disclosed concept;

FIG. 6A shows a side view of the arrangement shown in FIG. 5E of the can body mounted on the closing punch, with a closing die positioned to receive the second end of the can body prior to commencement of a process for flattening the second end of the can body, the closing die being shown in sectional view in order to show a flattening surface formed in the interior of the closing die body, in accordance with another embodiment of the disclosed concept;

FIG. 6B shows a perspective side view of the can body mounted on the closing punch and a sectional view of the closing die shown in FIG. 6A, after the closing die has been pressed onto the second end of the can body and has commenced flattening the second end of the can body, in accordance with another embodiment of the disclosed concept;

FIG. 6C shows the perspective side view of the can body mounted on the closing punch and the sectional view of the closing die shown in FIG. 6B, after the closing die has finished flattening the second end of the can body, in accordance with another embodiment of the disclosed concept;

FIG. 7A shows a side perspective view of a friction stir welding tooling assembly that is used to stir weld the seams formed at the second end of the can body after the flattening process shown in FIGS. 6A-6C, in accordance with a further embodiment of the disclosed concept;

FIG. 7B shows a side perspective view of a headstock and stir welding tool shown in FIG. 7A;

FIG. 8 shows a plan view of the second end of the can body after the second end has been flattened during the process shown in FIGS. 6A-6C;

FIG. 9A shows a side perspective view of the can body after the second end has been stir welded with the friction stir welding tooling assembly shown in FIGS. 7A-7B; and

FIG. 9B shows a perspective top view of the interior of the can body after the second end has been stir welded with the friction stir welding tooling assembly shown in FIGS. 7A-7B.

### DETAILED DESCRIPTION OF THE INVENTION

For purposes of illustration, embodiments of the disclosed concept will be described as applied to bases of beer/beverage cans, although it will become apparent that they could also be employed to other containers such as, for example and without limitation, cans for liquids other than beer and beverages.

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations and other physical characteristics related to the embodiments disclosed herein are not to be considered limiting on the scope of the disclosed concept.

Directional phrases used herein, such as, for example, clockwise, counterclockwise, left, right, front, back, top, bottom, upper, lower and derivatives thereof, relate to the orientation of the elements shown in the drawings and are not limiting upon the claims unless expressly recited therein.

As employed herein, the terms “can” and “container” are used substantially interchangeably to refer to any known or suitable container, which is structured to contain a substance (e.g., without limitation, liquid; food; any other suitable substance), and expressly includes, but is not limited to, food cans, as well as beverage cans, such as beer and soda cans.

As employed herein, the term “can end” refers to the lid or closure that is structured to be coupled to a can, in order to seal the can.

As employed herein, the term “number” shall mean one or an integer greater than one (i.e., a plurality).

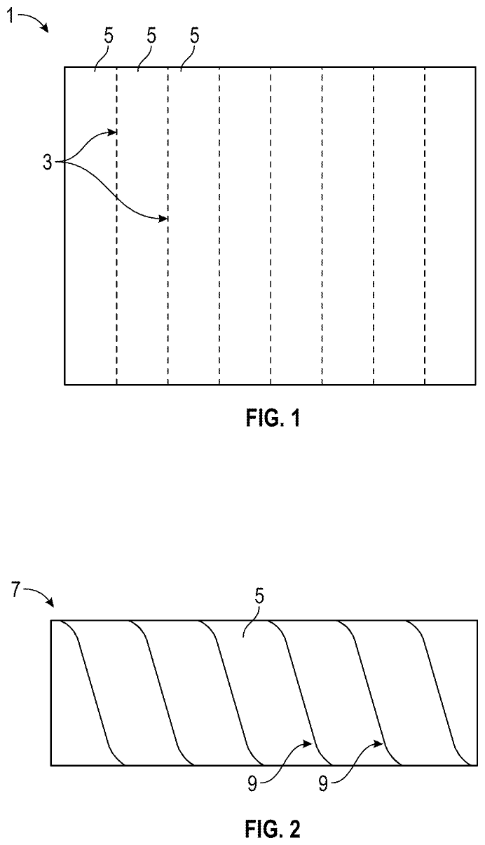

FIG. 1 shows a metal sheet 1 from which a plurality of can bodies for a two-piece metal container can be produced, in accordance with one non-limiting embodiment of the disclosed and claimed concept. The metal sheet 1 can be produced from any metal suitable for housing the contents of a two-piece metal container, such metal including but not limited to aluminum, tin-coated steel, or tin free steel. At a first stage of the manufacturing process, the metal sheet 1 is sheared along a plurality of shearing lines 3 (the shearing lines 3 being shown in dashed line in FIG. 1) in order to form a plurality of metal strips 5. For ease of illustration, only some of the shearing lines 3 and metal strips 5 are numbered in FIG. 1. It will be appreciated that the width and length of the metal sheet 1, as well as the width and length of the metal strips 5 produced from the metal sheet 1, can be adapted to produce can bodies of varying sizes without departing from the scope of the claimed and disclosed concept.

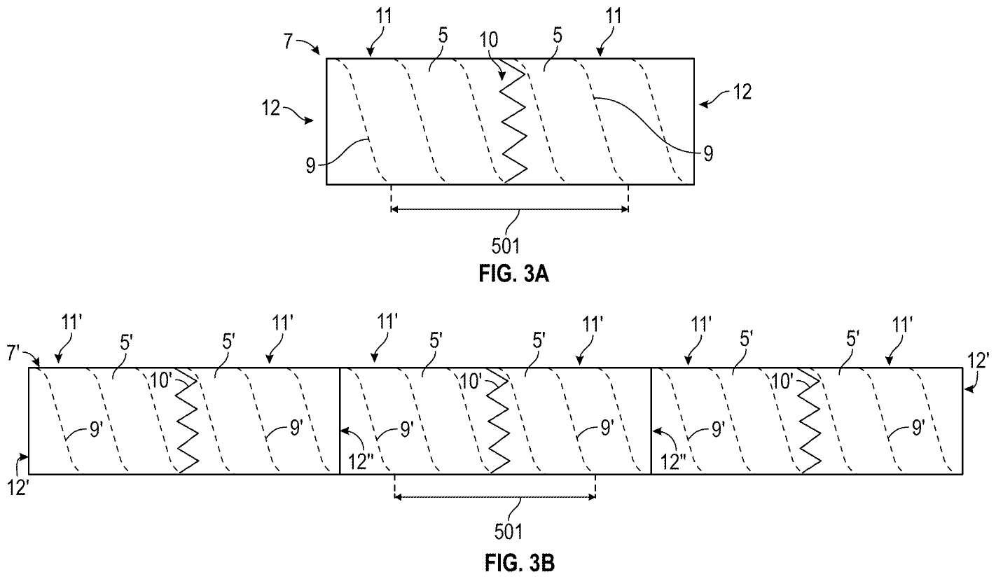

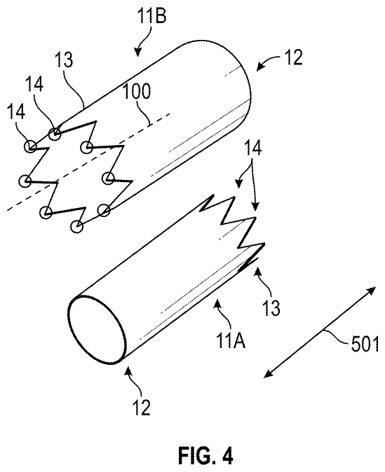

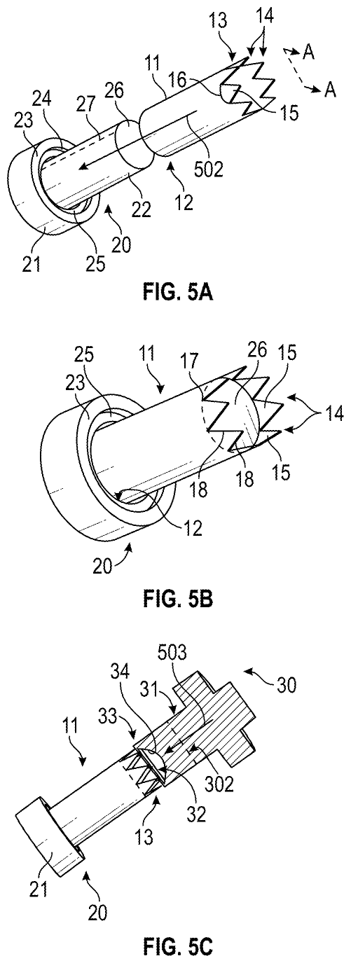

FIG. 2 shows a long tube 7 formed by rolling a single one of the metal strips 5 of FIG. 1 into an open cylinder, in accordance with one non-limiting embodiment of the disclosed and claimed concept. The metal strip 5 can, for example and without limitation, be formed into the long tube 7 by being rolled around a mandrel along a helix, similar to how the cardboard core of a paper towel roll is formed. The helical seam 9 can then be sealed, for example and without limitation, by friction stir welding. However, it is noted that any method suitable for forming a tube from a strip of material can be used to form the metal strip 5 into the long tube 7, without departing from the scope of the disclosed and claimed concept. It is noted that the helical seam 9 of the long tube 7 is not expected to be visible after friction stir welding. As such, the helical seam 9 is depicted in dashed line in FIGS. 3A and 3B and is not depicted in FIG. 4 or any subsequent figures.

Referring now to FIGS. 3A-3B and 4, FIG. 3A shows a first embodiment of the long tube 7 and a zigzagged path 10 along which the long tube 7 is cut in order to form two short tubes 11, and FIG. 4 shows the two short tubes 11 (numbered with reference numbers 11A and 11B) that result from cutting the long tube 7 along the zigzagged path 10 shown in FIG. 3A, in accordance with one non-limiting embodiment of the disclosed and claimed concept. As a result of cutting the long tube 7 along the zigzagged path 10 shown in FIG. 3A to form the pair of can bodies 11 shown in FIG. 4, each can body 11 comprises a first end 12 that forms a planar edge and a second end 13 disposed opposite the first end that comprises a plurality of burst points 14.

FIG. 3B shows a second embodiment of the long tube 7 (the second embodiment shown in FIG. 3B being referred to hereinafter as the long tube 7′) which can be formed using a metal strip 5′ that is significantly longer than the metal strip 5 that is rolled to form the long tube 7 shown in FIG. 3A. The only notable difference between the long tube 7 and the long tube 7′ is that multiple pairs of short tubes 11′ can be produced from the long tube 7′, whereas only one pair of short tubes 11 can be produced from the long tube 7. However, the short tubes 11 and the short tubes 11′ are structurally and functionally equivalent to each other. In order to form multiple pairs of can bodies 11′ from the long tube 7′ shown in FIG. 3B, multiple cuts are made to the long tube 7′, with cuts along zigzagged paths 10′ being alternated (relative to a length dimension 501 shown in FIGS. 3A and 3B) with cuts along planar paths 12″. The reference number 12′ is used to refer to each of the two ends of the long tube 7′ in order to signify that each end 12′ of the long tube 7′ already forms a planar edge when the long tube 7′ is formed, and the reference number 12″ is used to refer to planar paths along which the long tube 7′ needs to be cut in order to form additional planar edges for can bodies 11′. The planar paths 12″ are parallel to the ends 12′ of the long tube 7′. There is one planar path 12″ disposed in between any two successive zigzagged paths 10′ of the long tube 7′. Similarly, there is one zigzagged path 10′ disposed between any two successive planar paths 12″ of the long tube 7′, and for each given end 12′ of the long tube 7′, there is one zigzagged path 10′ disposed between the given end 12′ and the successive planar path 12″.

For the sake of brevity, the disclosed and claimed concept relating to forming a can body from a short tube 11 or 11′ is primarily described hereinafter by referencing the short tubes 11 shown in FIG. 3A, but it should be understood that a can body can be produced from a short tube 11′ in the same manner that a can body can be produced from a short tube 11. Because the short tubes 11 are intended to be made into can bodies, the short tubes 11 are referred to collectively hereinafter as the “can bodies 11” and referred to individually as a “can body 11”. In FIG. 4, the two can bodies 11 are numbered with the reference numbers 11A and 11B in order to denote that the two can bodies 11A and 11B were produced from the same long tube 7, but it should be noted that the can bodies 11A and 11B are assumed to be structurally identical, and that each can body 11A or 11B can be referred to as a “can body 11”.

For emphasis, all of the burst points 14 of the can body 11B are circled in FIG. 4, although only some of the burst points 14 of the can bodies 11 are numbered in FIG. 4, for ease of illustration. The reference number 12 is sometimes used herein to refer to the first end 12 of a given can body 11 as the “planar edge 12” of the given can body 11. The length of each can body 11 can be measured relative to the length dimension 501 as denoted in FIGS. 3A-3B and 4, and each can body 11 is substantially cylindrical in shape. More specifically, for each can body 11, there is some length measured relative to the planar edge 12 of the can body 11 up until which the can body 11 is an open cylinder, with such length being less than a distance between the planar edge 12 and any of the burst points 14. Because each can body 11 is substantially cylindrical, the planar edge 12 of each can body 11 comprises a circle when viewed in a plane orthogonal to the length dimension 501, as can be seen in FIG. 4, and it will be appreciated that the planar edge 12 coincides with a circumference of the can body 11. In addition, each can body 11 has a central axis 100 (only the central axis 100 of can body 11B being numbered in FIG. 4) that coincides with the center of the circle whose circumference coincides with the planar edge 12 of the can body 11.

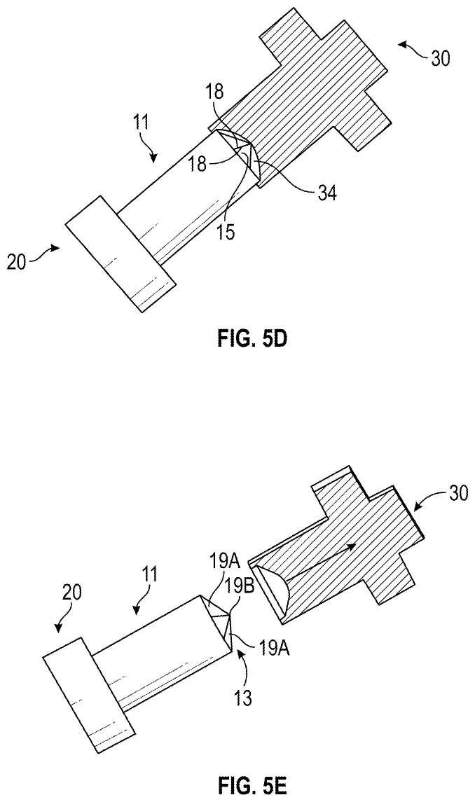

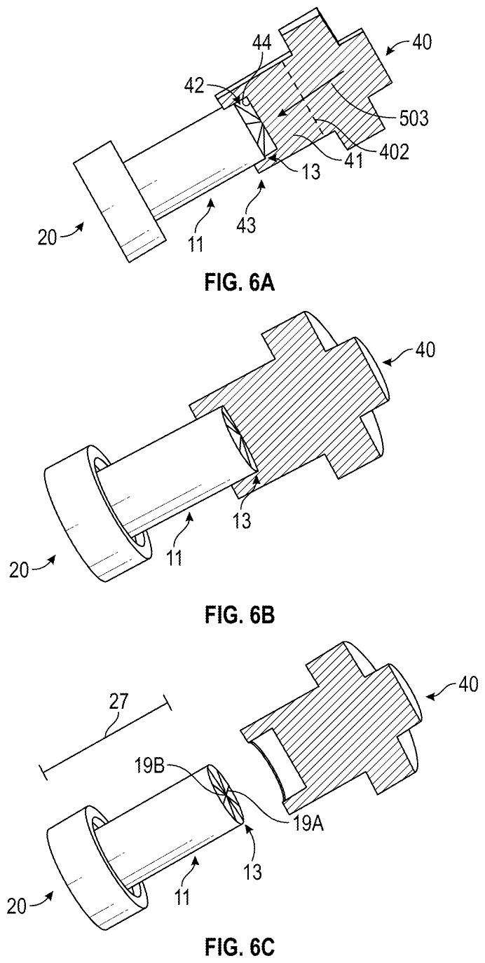

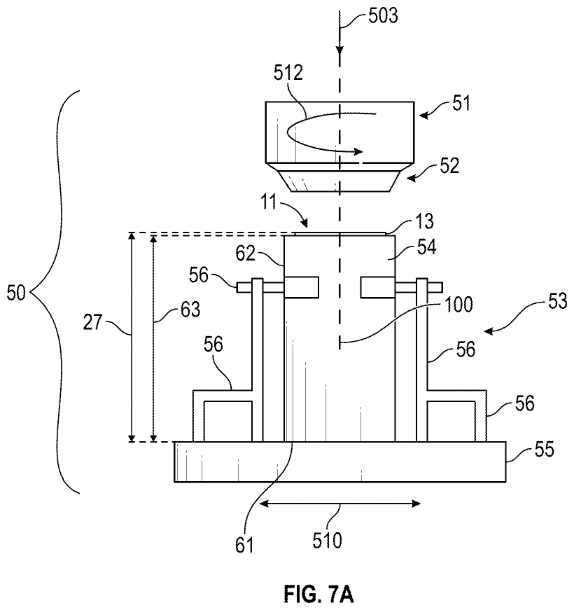

Referring now to FIGS. 5A-5E, the series of steps that each can body 11 undergoes in order to form the second end 13 of the can body 11 into a partially closed end is shown, in accordance with non-limiting embodiments of the disclosed and claimed concept. The steps illustrated in FIGS. 5A-5E are performed so that the partially closed second end 13 can eventually serve as a base of the can body 11 after undergoing additional manufacturing steps portrayed in FIGS. 6A-6C and FIG. 7A. In FIG. 5A, the can body 11 is shown positioned to be mounted onto a closing punch 20. It is noted that the closing punch 20 is not actually used to punch a hole through any components described in conjunction with the disclosed and claimed concept, but is instead used to stabilize the can body 11 through the various steps described hereinafter that are performed to form the second end 13 into a partially closed end. The closing punch 20 comprises a circular base 21 and a cylindrical support 22 extending from the circular base 21. The cylindrical support 22 is a cylinder and therefore inherently has a circumference and includes two circular faces. The circular base 21 comprises an outer wall 23 whose inner circumference 24 is greater than the circumference of the cylindrical support 22 such that a trough 25 is formed between the circumference of the cylindrical support 22 and the inner circumference 24 of the outer wall 23. While a first of the circular faces (not visible in the figures) of the cylindrical support 22 is joined to the circular base 21, the other circular face 26 faces away from the circular base 21.

Referring now to FIG. 5B in conjunction with FIG. 5A, the circumference of the cylindrical support 22 is smaller than the circumference of the can body 11. This enables the can body 11 to be mounted onto the cylindrical support 22 (as indicated by the arrow 502 in FIG. 5A) such that the cylindrical support 22 is inserted into the interior of the can body 11 and such that the planar edge 12 of the can body 11 is seated upon the trough 25 of the circular base 21, as shown in FIG. 5B. It is noted that each burst point 14 of the can body 11 forms the apex of a triangular formation 15 (some, but not all, of the burst points 14 and triangular formations 15 are numbered in FIGS. 5A and 5B). The burst points 14 can alternatively be referred to collectively as “apexes 14” or individually as an “apex 14”. Each triangular formation 15 comprises a triangle base 16 (for ease of illustration, only one triangle base 16 is numbered, in FIG. 5A). Each triangle base 16 is adjacent to the triangle bases 16 of two adjacent triangular formations 15 such that the sum of the lengths of all of the triangle bases 16 is equal to the circumference of the can body 11.

Accordingly, the circle formed by all of the adjacent triangle bases 16 can be referred to as the circumferential triangle base 17 (shown in dashed line in FIG. 5B and numbered only in FIG. 5B). For each given triangular formation 15, in addition to the triangle base 16, the triangular formation 15 also comprises two legs 18, with each leg 18 extending from the triangle base 16 toward the other leg 18 such that the two legs 18 meet to form the burst point 14 of the triangular formation 15. A height 27 of the cylindrical support 22 is numbered in FIG. 5A, and as can be seen in FIG. 5B, the closing punch 20 is proportioned such that the height 27 of the cylindrical support 22 is the same as the length of the can body 11 as measured between the planar edge 12 and the circumferential triangle base 17. Thus, when the can body 11 is mounted on the cylindrical support 22, the triangular formations 15 extend beyond the circular face 26 in a direction opposed to the circular base 21, such that the triangular formations 15 are not structurally supported by the cylindrical support 22.

Referring now to FIG. 5C, a folding die 30 is shown positioned to commence a process of folding the triangular formations 15 in order to form the can body second end 13 into a partially closed end. The folding die 30 comprises a body 31 with a circular cross section and is shown in sectional view in FIG. 5C, in order to show certain features formed in the interior of the body 31 that are used to fold the triangular formations 15. Specifically, the folding die 30 is portrayed in FIG. 5C (and FIGS. 5D-5E) as being cut along a cutting plane A-A drawn in FIG. 5A. The cutting plane A-A coincides with a diameter 302 of the folding die 30, and the cutting plane A-A and diameter 302 also coincide with the diameter of the can body 11. The body 31 of the folding die 30 is solid save for a fold-forming cutout 32 formed at a can receiving end 33 of the body 31. The fold-forming cutout 32 is convex, resulting in the interior of the body 31 comprising a concave folding surface 34.

Continuing to refer to FIG. 5C, the fold-forming cutout 32 is widest at the can receiving end 33 of the folding die 30, such that the circumference of the fold-forming cutout 32 continually decreases as the fold-forming cutout 32 extends from the can receiving end 33 further into the interior of the body 31. The can receiving end 33 of the folding die 30 is structured to receive the triangular formations 15 of the can body 11 in order to fold the burst points 14 toward the can body central axis 100 (numbered in FIG. 4), and the widest portion of the fold-forming cutout 32 is wider than the circumference of the can body 11. In order to fold the triangular formations 15 of the can body 11, the folding die 30 is positioned so that can receiving end 33 faces the burst points 14 of the can body 11, and then the folding die 30 is pushed toward the can body 11 as indicated by the arrow 503.

FIG. 5D shows the folding die 30 and can body 11 after the triangular formations 15 have been folded by the folding surface 34 such that the burst points 14 coincide with the can body central axis 100. Starting from the position shown in FIG. 5C, as the folding die 30 is pushed toward the can body 11 in the direction 503, the folding surface 34 engages the burst points 14. As the folding die 30 continues moving in the direction 503, the curvature of the concave folding surface 34 forces each triangular formation 15 to fold toward the central axis 100 of the can body 11 until each burst point 14 coincides with the central axis 100 and makes contact with every other burst point 14, with every leg 18 of every triangular formation 15 contacting an adjacent leg 18 of the adjacent triangular formation 15 and forming a seam 19A (some, but not all of the seams 19A are numbered in FIG. 5E). A seam 19B (numbered in FIG. 5E) is formed where all of the burst points 14 meet one another. The seams 19A and 19B can be referred to generally and collectively as the “seams 19”, and any of the seams 19A or 19B can be referred to generally and individually as a “seam 19”. FIG. 5E shows the can body 11 with the second end 13 remaining in a folded state after removal of the folding die 30 from the second end 13. The folded state of the second end 13 as shown in FIG. 5E is additionally referred to as “partially” closed due to the seams 19 not being sealed. It is noted that the shape of the second end 13 in its folded and partially closed state is non-planar and approximates the shape of a cone after undergoing folding by the folding die 30.

Referring now to FIGS. 6A-6C, the series of steps that each can body 11 undergoes in order to flatten the partially closed can body second end 13 into a planar surface after being folded with the folding die 30 is shown, in accordance with non-limiting embodiments of the disclosed and claimed concept. In FIG. 6A, a closing die 40 is shown positioned to commence the process of flattening the partially closed second end 13. The closing die 40 comprises a body 41 with a circular cross section and is shown in sectional view in FIG. 6A, in order to show certain features formed in the interior of the body 41 that are used to flatten the partially closed second end 13. Similarly to the portrayal of the folding die 30 in FIGS. 5C-SE, the closing die 40 is portrayed in FIG. 6A (and FIGS. 6B-6C) as being cut along the cutting plane A-A shown in FIG. 5A. The cutting plane A-A coincides with a diameter 402 of the closing die 40, and the cutting plane A-A and diameter 402 also coincide with the diameter of the can body 11. The body 41 of the closing die 40 is solid save for an end-flattening cutout 42 formed at a can receiving end 43 of the body 41. The end-flattening cutout 42 is cylindrical, resulting in the interior of the body 41 comprising a circular and planar flattening surface 44. The can receiving end 43 is structured to receive the can body 11 with the second end 13 facing the flattening surface 44.

FIG. 6B shows the closing die 40 and can body 11 after the flattening surface 44 has engaged the can body second end 13 and consequently flattened the can body second end 13. From the position shown in FIG. 6A, the closing die 40 is pushed toward the can body 11 in the direction 503 until the flattening surface 44 engages the seam 19B of the can body second end 13. As the closing die 40 continues moving in the direction 503, the planar nature of the flattening surface 44 forces the folded can body second end 13 to flatten until the triangular formations 15 are all disposed in the same plane. FIG. 6C shows the can body 11 with the second end 13 both partially closed and flattened after removal of the closing die 40 from the can body second end 13. The state of the can body second end 13 as shown in FIG. 6C is still referred to as “partially” closed due to the seams created between each pair of adjacent triangular formations 15 still not being sealed.

It is noted that the partially closed can body second end 13 is planar and approximates a circle after undergoing flattening by the closing die 40 as detailed in conjunction with FIGS. 6A-6C. The reference number 27 is used to refer to the height of the can body 11 after the can body second end 13 has undergone flattening and is in the state shown in FIG. 6C, as the reference number 27 was previously used in conjunction with the description of FIG. 5A to describe the length of the can body 11 as measured between the planar edge 12 and the circumferential triangle base 17 (which is the also same as the height 27 of the cylindrical support 22 shown in FIG. 5A).

After the partially closed can body second end 13 is flattened as detailed in conjunction with FIGS. 6A-6C, the seams 19 of the can body second end 13 must be sealed in order to render the can body second end 13 suitable for use as a can base. Referring now to FIGS. 7A and 7B, a friction stir welding tooling assembly 50 (referred to hereinafter as the “stir welding assembly 50” for brevity) in accordance with an example embodiment of the disclosed and claimed concept is shown. In FIG. 7A, the stir welding assembly 50 is shown positioned to commence a process of stir welding the seams 19 of the can body second end 13 after the flattening process depicted in FIGS. 6A-6C has been performed. The stir welding assembly 50 comprises a headstock 51, a stirring tool 52, and a can stabilizing arrangement 53. The can stabilizing arrangement 53 includes a holding vessel 54, a platform 55, and a number of fastening rods 56 (only some of the fastening rods 56 being numbered in FIG. 7A for ease of illustration).

The holding vessel 54 is cylindrical with a closed first end 61 and an open second end 62 opposite the first end 61. The first end 61 is fixed in position upon the platform 55. The fastening rods 56 are joined to both the holding vessel 54 and the platform 55 and help to further secure the position of the holding vessel 54 upon the platform 55. The can body 11 to be placed can be inserted within the interior of the holding vessel 54 at the open second end 62 of the holding vessel 54. FIG. 7A depicts the holding vessel 54 holding the can body 11 when the can body 11 is in its flattened and partially closed state (i.e. the state shown in FIG. 6C), with the can body second end 13 extending slightly beyond the second end 62 of the holding vessel 54. The holding vessel 54 is proportioned such that its height 63 is slightly less than the height 27 of the flattened and partially closed can body 11, and is also proportioned to prevent the can body 11 from moving laterally (i.e. in any direction 510 orthogonal to the central axis 100 of the can body 11) within the interior of the holding vessel 54.

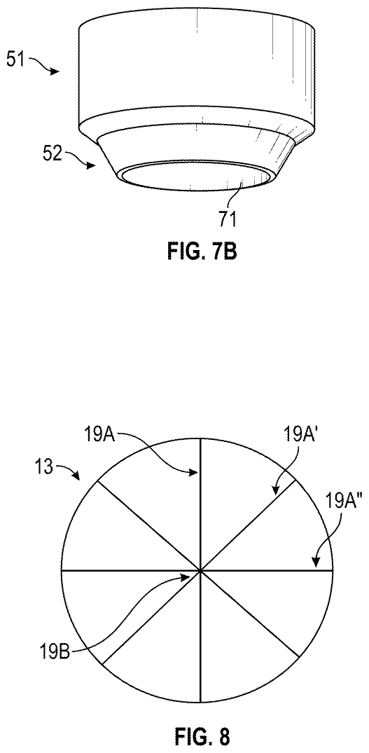

Referring briefly to FIG. 8, the flattened and partially closed can body second end 13 is shown. Three seams 19A, 19A′, and 19A″ formed by the legs 18 of adjacent triangular formations 15 are numbered in FIG. 8. All of the seams 19A, 19A′, and 19A″ can be referred to generally and collectively as the “seams 19A” and can be referred to generally and individually as a “seam 19A”. The prime symbol (i.e. ‘) is included in the reference numbers 19A’ and 19A″ in order to differentiate each unique seam 19A from the other seams 19A. It is noted that friction stir welding is typically performed by placing the center of the welding tool directly on the seam to be welded. For example, if a first end of each of the seams 19A, 19A′, and 19A″ is considered to be on the circumference of the can body second end 13 and a second end of each of the seams 19A, 19A′, and 19A″ is considered to be located at the seam 19B, then each seam 19A would typically be stir welded by initially placing the stir welding tool on the first end of the seam 19A and moving the stir welding tool toward the second end. In the case of sealing the seams 19 of the flattened and partially closed can body second end 13, stir welding in the typical fashion would necessitate welding in a star-like tool path. Stir welding the seams 19 of the can body second end 13 in this typical fashion would be very time consuming, especially compared with the rate at which cans are manufactured.

Referring once more to FIGS. 7A and 7B, the stir welding assembly 50 is designed to stir weld the seams 19 in a more time efficient manner than the typical fashion of stir welding discussed above in conjunction with FIG. 8. In particular, the stirring tool 52 is structured to be oversized relative to the stirring tool that would conventionally be used to stir weld a seam 19 in the previously detailed typical fashion. Specifically, the stirring tool 52 comprises a circular welding surface 71 (FIG. 7B) whose circumference is greater than the circumference of the can body 11. It is noted that the circumference of the welding surface 71 does not need to be significantly greater than the circumference of the can body 11; it is sufficient for the welding surface 71 to be just large enough to enable the welding surface 71 to make contact with the entirety of the flattened and partially closed can body second end 13 when the stirring tool 52 is pressed against the can body second end 13.

The holding vessel 54 is positioned to ensure that, when the can body 11 is held within the holding vessel 54, the center of the stirring tool welding surface 71 is aligned with the central axis 100 of the can body 11. The stirring tool 52 is coupled to the headstock 51 in a manner that enables the stirring tool 52 to rotate or spin (as indicated by the arrow 512 in FIG. 7A) relative to the headstock 51. In order to stir weld the seams 19 of the can body second end 13, the headstock 51 pushes the stirring tool 52 toward the can body second end 13 (as indicated by the arrow 503 in FIG. 7A) until the welding surface 71 engages the can body second end 13. The headstock 51 then spins the stirring tool 52 (as indicated by arrow 514 in FIG. 7A) around the central axis 100 of the can so that the entire external surface area of the can body second end 13 is friction stir welded at the same time by the stirring tool 52, rather each individual seam 19 being separately friction stir welded as previously described in conjunction with FIG. 8. Stir welding the entire surface area of the can body second end 13 completely closes all seams 19 of the can body second end 13. It is noted that the headstock 51 only needs to be capable of moving linearly toward (i.e. in the direction 503) and away from (i.e. in a direction opposite the direction 503) the stabilizing arrangement 53.

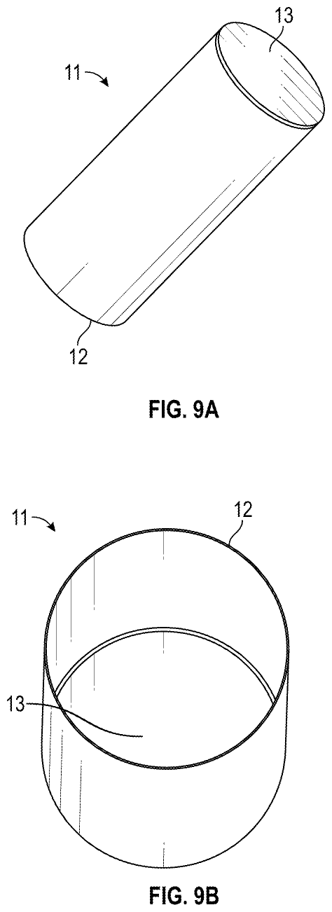

FIGS. 9A and 9B show the can body 11 after completion of stir welding of the second end 13 detailed in conjunction with FIGS. 7A and 7B. FIG. 9A shows a perspective side view of the exterior of the can body 11, while FIG. 9B shows a partial perspective top view of the interior of the can body 11. Once the can body second end 13 is closed as shown in FIGS. 9A and 9B, the second end 13 can be domed in any manner known in the relevant technical field so that the second end 13 can function as a can base. For example and without limitation, a dome geometry can be put into the body of the can body 11 with a press that draws the material of the second end 13 around a dome die plug.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of manufacturing a body of a container, the method comprising:
providing a metal strip;
winding the strip into a tube;
cutting along a zigzagged path between a first end of the tube and a second end of the tube opposite the first end to produce a can body, with a first end of the can body comprising a planar edge and a second end of the can body comprising a plurality of triangular formations, each triangular formation comprising an apex;
forming a folded end by folding all of the triangular formations toward a central axis of the can body until each apex coincides with the central axis;
forming a flattened end by flattening the folded end; and
friction stir welding an entire external surface area of the flattened end at one time.

2. The method of claim 1,
wherein winding the strip into a tube comprises winding the strip along a helix such that a helical seam is formed.

3. The method of claim 2, further comprising:
friction stir welding the helical seam.

4. The method of claim 1, further comprising:
mounting the can body onto a closing punch prior to forming the folded end,
wherein the closing punch comprises a cylindrical support extending from a circular base,
wherein the cylindrical support comprises two circular faces, with a first of the circular faces being joined to the circular base and a second of the circular faces being positioned opposite the first circular face,
wherein the cylindrical support is structured to be inserted into the interior of the can body such that the planar edge of the can body is seated upon the circular support, and
wherein the cylindrical support is structured such that, when the can body is mounted on the closing punch, the triangular formations extend beyond the second circular face of the cylindrical support and away from the circular base.

5. The method of claim 4,
wherein the folding is actuated with a folding die,
wherein the folding die comprises a cylindrical body,
wherein the folding die cylindrical body is solid save for a fold-forming cutout formed at a can receiving end of the cylindrical body,
wherein the fold-forming cutout is convex such that a concave folding surface is formed within an interior of the folding die cylindrical body, and
wherein folding all of the triangular formations toward the central axis of the can body comprises pushing the concave folding surface toward the folded end of the can body such that the concave folding surface engages the apexes of all of the triangular formations.

6. The method of claim 4,
wherein the flattening is actuated with a closing die,
wherein the closing die comprises a cylindrical body,
wherein the closing die cylindrical body is solid save for an end-flattening cutout formed at a can receiving end of the cylindrical body,
wherein the end-flattening cutout is cylindrical such that a circular and planar flattening surface is formed within an interior of the cylindrical body, and
wherein flattening the folded end comprises pushing the flattening surface toward the folded end such that the concave folding surface engages the apexes of all of the triangular formations and pushes the folded end until all of the triangular formations are disposed in one plane.

7. The method of claim 4,
wherein the friction stir welding is actuated with a friction stir welding tooling assembly, the friction stir welding tooling assembly comprising:
a headstock;
a stirring tool comprising a planar welding surface and coupled to the headstock in a manner that enables the stirring tool to rotate relative to the headstock; and
a can stabilizing arrangement structured to hold the can body fixed in position such that the flattened end faces the welding surface,
wherein the welding surface has a greater surface area than the flattened end, and
wherein the friction stir welding is actuated by aligning a center of the welding surface with the central axis of the can body, rotating the stirring tool about the central axis of the can body, and pushing the stirring tool toward the flattened end until the welding surface engages the flattened end.

8. The method of claim 7,
wherein the welding surface is circular and has a greater circumference than the can body.

9. The method of claim 1, further comprising:
doming the flattened surface after the friction stir welding.

10. The method of claim 1, further comprising:
producing the metal strip by shearing a metal sheet into a plurality of metal strips; and
for each given metal strip of the plurality of metal strips, performing:
the winding the strip into a tube,
the cutting along a zigzagged path,
the forming a folded end,
the forming a flattened end, and
the friction stir welding.

11. The method of claim 10,
wherein for each given metal strip of the plurality of metal strips, the winding the strip into a tube comprises winding the strip along a helix such that a helical seam is formed, and
wherein, for each tube formed, the method further comprises friction stir welding the helical seam.

12. The method of claim 1,
wherein the cutting along the zigzagged path produces another can body from the tube, with a first end of the another can body comprising another planar edge and a second end of the another can body comprising another plurality of triangular formations, each triangular formation of the another plurality of triangular formations comprising an apex.

13. A can body tooling assembly, the can body tooling assembly comprising:
a closing punch structured to mount a cylindrical can body and comprising a circular base and a cylindrical support extending from the circular base;
a folding die, the folding die comprising a first solid body formed with a fold-forming cutout at a can receiving end;
a closing die, the closing die comprising a second solid body formed with an end-flattening cutout at a can receiving end; and
a friction stir welding tooling assembly, the friction stir welding tooling assembly comprising:
a headstock;
a stirring tool comprising a planar welding surface and coupled to the headstock in a manner that enables the stirring tool to rotate relative to the headstock; and
a can stabilizing arrangement structured to hold the can body fixed in position such that a flattened end of the can body faces the welding surface,
wherein the fold-forming cutout is convex such that a concave fold-forming surface is formed in the interior of the first solid body.

14. The can body tooling assembly of claim 13,
wherein the end-flattening cutout is cylindrical such that a circular and planar end-flattening surface is formed in the interior of the second solid body.

15. The can body tooling assembly of claim 13,
wherein the cylindrical support of the closing punch comprises two circular faces, with a first of the circular faces being joined to the circular base and a second of the circular faces being positioned opposite the first circular face, and
wherein the cylindrical support is structured to be inserted into the interior of the can body such that a planar edge of the can body can be seated upon the circular support.

16. The can body tooling assembly of claim 13,
wherein the headstock is configured to only move linearly toward and away from the stabilizing arrangement in order to completely weld a base of the can body.

17. A container body, the container body comprising:
a first end comprising a planar edge; and
a second end disposed opposite the first end,
wherein the second end forms a planar base comprising a plurality of triangular formations welded together.

18. The container body of claim 17,
wherein a portion of the container body extending between the planar base and the first end comprises a strip of material wound into a helix such that a helical seam is formed.

19. The container body of claim 18,
wherein the helical seam is friction stir welded.

20. A method of manufacturing a body of a container, the method comprising:
providing a metal strip;
winding the strip into a tube;
between a first end of the tube and a second end of the tube opposite the first end, alternating between cutting along a zigzagged path and cutting along a planar path to produce a plurality of can bodies, with a first end of each can body comprising a planar edge and a second end of each can body comprising a plurality of triangular formations, each triangular formation comprising an apex;
for a given one of the can bodies, forming a folded end by folding all of the triangular formations toward a central axis of the given can body until each apex coincides with the central axis;
for the given one of the can bodies, forming a flattened end by flattening the folded end; and
for the given one of the can bodies, friction stir welding an entire external surface area of the flattened end at one time.
